(19) United States
(12) Patent Application Publication
(10) Pub. No.: US 2006/0275660 A1
(43) Pub. Date: Dec. 7, 2006

(54) Process for producing high-strength polypyrrole film

(75) Inventors: Tetsuji Zama, Osaka (JP); Susumu Hara, Osaka (JP); Shingo Sewa, Osaka (JP)

Correspondence Address: NOVAK DRUCE & QUIGG, LLP, 1300 EYE STREET NW, 400 EAST TOWER, WASHINGTON, DC, 20005, US

(73) Assignee: EAMEX CORPORATION, Osaka (JP)

(21) Appl. No.: 10/536,940

(22) PCT Filed: Dec. 1, 2003
(86) PCT No.: PCT/JP03/15312

§ 371 Date: Feb. 21, 2006

(30) Foreign Application Priority Data
Nov. 29, 2002 (JP) 2002-348607

(51) Int. Cl. H01M 4/60; C25B 3/10

(52) U.S. Cl. 429/213; 205/58; 205/419

(57) ABSTRACT

In polypyrrole films obtained by a process for producing polypyrrole films comprising the steps of forming polypyrrole layers on working electrodes by electrochemical polymerization methods using pyrroles and/or pyrrole derivatives, followed by stripping off said polypyrrole layers, wherein said electrochemical polymerization methods use electrolytes including organic compounds comprising at least one bond or one functional group of ether bond, ester bond, carbonate bond, hydroxyl group, nitro group, sulfone group, and nitryl group and/or halogenated hydrocarbon as lo solvents and wherein said electrolytes include anions including trifluoromethanesulfonate ion and/or plural of fluorine atoms which bond to central atom and said working electrodes are metal electrodes, conductivity can be stably sustainable in the presence of oxygen and are excellent in mechanical strength.

### FIELD OF THE INVENTION

The present invention relates to process for producing polypyrrole films excellent in mechanical strength and polypyrrole films. The present invention also relates to process for forming a polypyrrole layer in which polypyrrole films are formed as a layer on a metal surface of a substrate and a substrate on which polypyrrole films are formed.

### BACKGROUND ART

Since conductive polymer films are light in weight compared with inorganic conductor such as conductive metal compounds and the like, and since it is easy to obtain conductive polymer films with uniform conductivity, application of conductive polymer films to obtain effects of prevention of energization and of charge, discharge and the like has been studied. Conductive polymers in a doped state are composed of partially positive-charged and dopant anions and said conductive polymers show high conductivity in this state. Electrochemical polymerization used for producing conductive polymers usually includes methods of forming conductive polymers on working electrodes as films. Addition of monomer components such as pyrrole and the like to electrolytic solutions, which include dopant anions, followed by applying voltages between working electrodes and counter electrodes in said electrolytic solutions, and applying voltage to both electrodes gives conductive films. See (pages 70 to 73 of) “Conductive polymers” 8^{th} edition by Naoya Ogata, published by Scientific K. K, Feb. 10, 1990.

Conducive polymers are composed of various kinds of resin-based conductive polymers such as polypyrrole, polyacetylene, and the like, and since few of conductive polymers in a doped state are stable in the presence of oxygen such as in the air, there are few conductive polymers with stable conductivity used for practical purposes. Conductive polymer films whose doped state is stable in the presence of oxygen, that is, practical conductive polymer films capable of sustaining conductivity include polypyrrole films using pyrrole and/or pyrrole derivatives as monomers and polyaniline films using aniline and/or aniline derivatives as monomers.

Polyaniline films have stable conductivity, however, conductivity is generally about 10 S/cm, lower than that of polypyrrole films of 10² S/cm. Therefore, as conductive polymer films, polypyrrole films are preferable from the practical view point.

However, compared with general-purpose high performance plastic films, polypyrrole films do not have sufficient mechanical strength in general and therefore, although they can preferably be used for electrodes and the like in a package which do not require high mechanical strength, said polypyrrole films could not preferably be used for exterior films or flexible electrodes which require high mechanical strength.

The object of the present invention is to provide process for producing polypyrrole films with excellent mechanical strength which can be stably sustained conductivity in the presence of oxygen, and to provide polypyrrole films and polypyrrole layers which are the protection layers with excellent mechanical strength and stably sustained conductivity in the presence of oxygen.

### SUMMARY OF THE INVENTION

The present invention relates to a process for producing polypyrrole films comprising the steps of forming polypyrrole layers on working electrodes by electrochemical polymerization in which pyrrole and/or pyrrole derivatives are/is used as monomers and stripping off said polypyrrole layers, thereby obtaining polypyrrole films, wherein said electrochemical polymerization methods use electrolytes which include organic compounds comprising at least one bond or one functional group of ether bond, ester bond, carbonate bond, hydroxyl group, nitro group, sulfone group, and nitryl group and/or halogenated hydrocarbon as solvents and wherein said electrolytes include anions including trifluoromethanesulfonate ion and/or plural of fluorine atoms which bond to central atom, and said working electrodes are metal electrodes.

By using said process, polypyrrole films with excellent mechanical strength and being capable of stably sustaining conductivity even in the presence of oxygen can be obtained. While tensile strength of general-purpose high performance plastics is about 60 MPa, polypyrrole films obtained by the present invention has tensile strength of not less than 60 MPa, and therefore, greater mechanical strength (tensile strength) can be obtained with respect to polypyrrole films obtained in the present invention than general-purpose high performance plastics.

Since polypyrrole films obtained by the present invention have the same or greater tensile strength than general-purpose high performance plastics do, they are preferable for the uses which require mechanical strength. Since in said polypyrrole films, resin components forming films have conductivity, conductive fillers such as metal powders, conductive metal oxides, carbon, and the like need not be added, polypyrrole films with lighter weight and with large mechanical strength even as thin films can easily be obtained.

In addition, the present invention also relates to methods for forming coating layers forming polypyrrole layers on metal surfaces of substrates by electrochemical polymerization in which pyrrole and/or pyrrole derivatives are/is used as monomers, wherein said substrates are used as working electrodes in said electrochemical polymerization and said electrochemical polymerization methods use electrolytes which include organic compounds comprising at least one bond or one functional group of ether bond, ester bond, carbonate bond, hydroxyl group, nitro group, sulfone group, and nitryl group and/or halogenated hydrocarbon as solvents and wherein said electrolytes include anions including trifluoromethanesulfonate ion and/or plural of fluorine atoms which bond to central atom.

By using forming methods of coating layers of the present invention, without stripping off polypyrrole layers obtained on working electrodes, polypyrrole films can be directly formed on metal surfaces of metal substrates and therefore, polypyrrole films can be easily formed in view of operational process.

### DETAILED DESCRIPTION OF THE PREFERRED EMBODIMENTS

The present invention relates to a process for producing polypyrrole films comprising the steps of forming polypyrrole layers on working electrodes by electrochemical polymerization methods which use pyrroles and/or pyrrole derivatives as a monomer and stripping off said polypyrrole layers, wherein said electrochemical polymerization methods use electrolytes which include organic compounds comprising at least one bond or one functional group of ether bond, ester bond, carbonate bond, hydroxyl group, nitro group, sulfone group, and nitryl group and/or halogenated hydrocarbon as solvents, wherein said electrolytes include anions including trifluoromethanesulfonate ion and/or plural of fluorine atoms which bond to central atom and said working electrodes are metal electrodes. Polypyrrole films obtained by the above mentioned producing methods have excellent mechanical strength. Although the reason thereof is not clear, it is assumed that said polypyrrole films have excellent tensile strength since polypyrrole molecular chains with large degree of polymerization are entangled and form dense films.

(Dopant)

In the production method of polypyrrole films of the present invention, electrolytes used for electrochemical polymerization includes organic compounds (pyrrole and/or pyrrole derivatives) and anions which include trifluoromethanesulfonate ion and/or plural of fluorine atoms which bond to central atom. By conducting electrochemical polymerization using said electrolytes, polypyrrole films with good conductivity and mechanical strength can be obtained. By the above mentioned electrochemical polymerization, anions which include trifluoromethanesulfonate ion and/or plural of fluorine atoms which bond to central atom are taken in polypyrrole films as dopants.

Although the content of said anions which include trifluoromethanesulfonate ion and/or plural of fluorine atoms which bond to central atom in electrolytic solutions is not specifically limited, they are preferably contained in 0.1 to 30% by weight, and more preferably contained in 1 to 15% by weight in electrolytic solutions.

Trifluoromethanesulfonate ion is a compound represented by the chemical formula of CF₃SO₃⁻. Further, anions which include plural of fluorine atoms which bond to central atom have structures in which plural of fluorine atoms bond to central atom such as boron, phosphorus, antimony, arsenic, and the like. Although anions which include plural of fluorine atoms which bond to central atom are not specifically limited, tetrafluoroborate ion (BF₄⁻), hexafluorophosphate ion (PF6⁻), hexafluoroantimonate ion (SbF₆⁻), and hexafluoroarsenate ion (AsF₆⁻) can be exemplified. Among them, CF₃SO₃⁻, BF₄⁻, and PF₆⁻ are preferable from the view point of safety to human bodies and the like, and CF₃SO₃⁻ and BF₄⁻ are more preferable. In addition, as represented by CF₃SO₃⁻, anions in which dopants include plural of fluorine atoms which bond to central atom and in which more than one functional group larger than fluoro group is bonded with central atom are preferable. By using anions in which dopants include plural of fluorine atoms which bond to central atom and in which more than one functional group larger than fluoro group bond to central atom, polypyrrole films obtained by the production method of the present invention are excellent in tensile strength and in tensile breaking elongation, and therefore, they are strong against force in the direction of extending horizontal to a film surface and are hard to break. Regarding said anions which include plural of fluorine atoms which bond to central atom, one species of anion may be used or plural species of anions may also be used together and further, they may be used together with anions which include trifluoromethanesulfonate ion and plural of fluorine atoms which bond to central atom.

(Solvents in Electrolytes)

In the production method of polypyrrole films of the present invention, solvents included in electrolytic solutions for electrochemical polymerization include organic compounds comprising at least one bond or one functional group of ether bond, ester bond, carbonate bond, hydroxyl group, nitro group, sulfone group, and nitryl group and/or halogenated hydrocarbon as solvents of electrolytes. More than two species of these solvents may be used together. By conducting electrochemical polymerization using electrolytes at the time of electrochemical polymerization, by the synergistic effect with said dopants, polypyrrole films with preferable conductivity and mechanical strength can be obtained. Further, it is preferable that bond or functional groups which said organic compounds have are ester bond and/or hydroxyl group functional group since films with good film quality and particularly, great mechanical strength can be obtained.

Said organic compounds include 1,2-dimethoxyethane, 1,2-diethoxyethane, tetrahydrofuran, 2-methyltetrahydrofuran, 1,4-dioxane (so far, organic compounds including ether bond), γ-butyrolactone, ethyl acetate, n-butyl acetate, tert-butyl acetate, 1,2-diacetoxyethane, 3-methyl-2-oxazolidinone, methyl benzoate, ethyl benzoate, butyl benzoate, dimethyl phthalate, diethyl phthalate (so far, organic compounds including ester bond), propylene carbonate, ethylene carbonate, dimethyl carbonate, diethyl carbonate, methyl ethyl carbonate (so far, organic compounds including carbonate bond), ethylene glycol, 1-butanol, 1-hexanol, cyclohexanol, 1-octanol, 1-decanol, 1-dodecanol, 1-octadecanol (so far, organic compounds including hydroxyl group), nitromethane, nitrobenzene (so far, organic compounds including nitro group), sulfolane, dimethyl sulfone (so far, organic compounds including sulfone group), and acetonitrile, butyronitrile, benzonitrile (so far, organic compounds including nitrile group). In addition, although organic compounds including hydroxyl group are not specifically limited, they are preferably polyalcohol or mono alcohol with a carbon number of not less than 4 for preparing films with great mechanical strength. Further, other than said examples, said organic compounds may be organic compounds which include two or more bond or functional groups out of ether bond, ester bond, carbonate bond, hydroxyl groups, nitro groups, sulfone groups, and nitrile groups with any combinations in a molecule. Examples of these include methyl 3-methoxypropionate and 2-phenoxyethanol.

In addition, halogenated hydrocarbon which is included in electrolytic solutions as solvent in the present invention is not specifically limited as long as at least one of hydrogen atoms in hydrocarbon is replaced by halogen atom and can stably be present under the condition of electrochemical polymerization as liquid. As said halogenated hydrocarbon, for example, dichloromethane and dichloroethane can be exemplified. Only one species of said halogenated hydrocarbons can be used as a solvent in said electrolytic solution, two or more species can also be used together. In addition, said halogenated hydrocarbon can be used with above mentioned organic compounds as a mixture as solvents in said electrolytic solutions.

(Metal Electrodes)

Production methods of polypyrrole films of the present invention uses metal electrodes as working electrodes in which conductive polymers are polymerized at the time of electrochemical polymerization. Compared with when electrodes whose main materials are non-metal materials such as electrodes made of ITO glasses, NESA glasses, or the like are used, mechanical strength of obtained conductive polymers is improved by using metal electrodes at the time of electrochemical polymerization.

Said metal electrodes are not specifically limited as long as they are mainly made of metals, and electrodes made of such elements as Pt, Ti, Ni, Ta, W, Au and the like can be used as a form of simple body or alloy thereof. Since mechanical strength of produced polypyrrole films is good and further, since electrodes can easily be obtained, it is particularly preferable that metals of said metal electrodes are Ni and Ti. In addition, said metal electrodes are preferable for obtaining films with good impact resistance since obtained polypyrrole films have high tensile breaking elongation.

(Condition for Electrochemical Polymerization)

As electrochemical polymerization methods used for production methods of conductive polymers of the present invention, publicly known electrochemical polymerization methods can be used as electrochemical polymerization of monomers of conductive polymers and such methods include constant potential methods, constant current methods, and potential sweep methods. For example, said electrochemical polymerization methods are preferably conducted with current density of 0.01 to 20 mA/cm² and with a reaction temperature of −70 to 80° C., and in order to obtain conductive polymers with good film quality, said electrochemical polymerization methods are preferably conducted with current density of 0.1 to 2 mA/cm² and with a reaction temperature of −40 to 40° C., and further preferably with a reaction temperature of −30 to 30° C.

(Monomers of Conductive Polymers)

In the production methods of polypyrrole films of the present invention, monomers of polypyrrole included in electrolytes for electrochemical polymerization are not specifically limited as long as they are pyrrole and/or pyrrole derivatives and compounds which show conductivity by converting into polymers by the oxidation in the process of electrochemical polymerization. As said pyrrole derivatives, 1-methylpyrrole, 3-methyl pyrrole, or 1-phenylpyrrole can be used. In addition, it is preferable that said monomers are pyrroles for obtaining polymers with good film quality with easy electrochemical polymerization. Further, said monomers can be used together in combinations of two or more of them.

(Other Additives)

In the production methods of polypyrrole films of the present invention, above mentioned specific solvents may be included in electrolytes used for electrochemical polymerization methods and monomers of conductive polymers may be included in electrolytes including trifluoromethanesulfonate ion and/or plural of fluorine atoms which bond to central atom, and further, other publicly known additives may be included such as polyethylene glycol, polyacrylamide, and the like.

(Polypyrrole Films)

In the production method of polypyrrole films in the present invention, by polymerizing polypyrrole layers by electrochemical polymerization methods using pyrroles and/or pyrrole derivatives as monomers, polypyrroles are formed on working electrodes. By stripping off filmy polypyrrole formed on these working electrodes, from working electrodes, polypyrrole films can be obtained. In obtained polypyrrole films, conductivity can stably be sustained in the presence of oxygen and can be used as conductive resin films with excellent mechanical strength.

As methods of stripping off filmy polypyrrole, formed on working electrodes by electrochemical polymerization methods, from working electrodes, publicly known methods can be employed for stripping and for example, filmy polypyrrole can be stripped off by immersing it in organic solvents or water and depending on the case, with tweezers. Shapes of said polypyrrole films are not specifically limited as long as they are thin films. Said polypyrrole films may be formed into tubular shapes, cylindrical shapes, prismatic shapes, fibrous shapes, and the like by publicly known methods. Said polypyrrole films can be used as conductive layers and coating layers of substrates can be prepared by laminating these on surfaces of substrates.

Although thickness of said polypyrrole films is not specifically limited, they can preferably be used as films with thickness of 1 to 200 μm. When said film thickness is less than 0.5 μm, it is difficult to strip off polypyrrole layers formed on working electrodes. On the other hand, obtaining films with thickness of not less than 200 μm by electrochemical polymerization requires a long time and therefore less effective and also, film quality deteriorates.

(Forming Methods of Coating Layers of polypyrrole Films)

In addition, the present invention relates to forming methods of coating layers which form polypyrrole films on metal surfaces of substrates by electrochemical polymerization methods which use pyrrole and/or pyrrole derivatives as monomers, wherein said substrates are used as working electrodes in said electrochemical polymerization methods, and electrolytes including organic compounds comprising at least one bond or one functional group of ether bond, ester bond, carbonate bond, hydroxyl group, nitro group, sulfone group, and nitryl group and/or halogenated hydrocarbon as solvents are used in the electrochemical polymerization, and said electrolytes include trifluoromethanesulfonate ion and/or plural of fluorine atoms which bond to central atom. Said methods of forming coating films are used when working electrodes are substrates provided with metal surfaces in said producing methods of polypyrrole films. When polypyrrole films with excellent mechanical strength and with stably sustainable conductivity even in the presence of oxygen are formed on substrates provided with metal surfaces, by using methods of forming coating films of the present invention, polypyrrole layers can be formed directly on metal surfaces of substrates without any process of obtaining polypyrrole films by stripping off polypyrrole layers obtained on working electrodes and therefore, polypyrrole coating films can be formed more easily than laminating films obtained by said production methods of polypyrrole films on substrates.

In methods of forming coating films of the present invention, regarding organic compounds comprising at least one bond or one functional group of ether bond, ester bond, carbonate bond, hydroxyl group, nitro group, sulfone group, and nitryl group and/or halogenated hydrocarbon which are solvents included in electrolytes at the time of electrochemical polymerization, same solvents included in electrolytes at the time of electrochemical polymerization in the production methods of said polypyrrole films are used. In addition, in methods of forming coating films of the present invention of said polypyrrole films, anions containing trifluoromethanesulfonate ion and/or plural of fluorine atoms which bond to central atom included in said electrolytes are the same as anions containing trifluoromethanesulfonate ion and/or plural of fluorine atoms which bond to central atom included in said electrolytes at the time of polymerization in the production methods of said polypyrrole films.

Said substrates are not specifically limited as long as they can be used as working electrodes and are provided with metal surfaces and portions except where polypyrrole layers are formed may be coated. Metal surfaces on which polypyrrole layers are formed are not specifically limited as long as pyrroles can be polymerized and simple substances or alloys of such elements as Pt, Ti, Ni, Ta, W, Au, and the like can be used. It is particularly preferable that Ni and Ti are used as metals of said metal electrodes since mechanical strength of generated polypyrrole layers is good and further, electrodes can easily be obtained.

Although film thickness of polypyrrole layers formed by the methods of forming coating layers of the present invention are not specifically limited, those with film thickness of 0.1 to 200 μm can preferably be used. When said film thickness is less than 0.1 μm, preparation of films with uniform film thickness is difficult and when said film thickness exceeds 200 μm, due to electric resistance by polypyrrole layers formed on substrate surfaces, polymerization on polypyrrole layer surfaces becomes difficult.

(Use)

Since polypyrrole films obtained by the production methods of the present invention and polypyrrole layers obtained by forming methods of coating layers have conductivity and excellent mechanical strength, they can preferably be used as conductive layers or films which are formed into equipments, instruments, or accessories thereof for office automations, homes, offices, automobiles and aircrafts, construction materials, medical equipments, and the like. They can also preferably be used as wrapping films or its conductive layers, and other films for machines and tools or accessories required conductivity. Said polypyrrole films and said polypyrrole layers can preferably be used for the purpose of prevention of charge, prevention of electromagnetic wave and energization. Said polypyrrole films or said polypyrrole layers can preferably be used for conductive films or conductive layers which are used for floor materials including conductive floor materials, conductive wall materials and the like or mats such as floor materials for clean rooms, food hygiene rooms, hospital measurement rooms, mats for automobiles, operation chair mats for operating computers, mats for floor surfaces underlaid doorway, mats for floor surfaces underlaid within elevators and in front of automatic doors of elevator halls, door mats, or floor carpets, and the like for the prevention of charge. Said polypyrrole films and said polypyrrole layers can preferably be used for conductive films or conductive layers such as member materials against static electricity electronic machines and accessories thereof, copying machines and facsimile machines as well. Further, said polypyrrole films and polypyrrole layers can preferably be used for conductive films or conductive layers of materials used for products for clean rooms such as overalls, shoes, carpets, chairs, desks, and the like. Said polypyrrole films and polypyrrole layers can preferably be used for conductive films or conductive layers for foods, drug medicines, textile products, IC accessories, wrappings for powdery foods, wrappings for drug medicines, and wrappings for textile products for the prevention of charge as well. For uses of preventing charge, other than above mentioned uses, said polypyrrole films and polypyrrole layers can preferably be used for conductive adhesive tapes for not only fixing cathode-ray tubes but also for removing static electricity and electronic wave accumulated on outer peripheries of cathode-ray tubes by energizing, or said polypyrrole films and polypyrrole layers can preferably be used for conductive films or conductive layers for housing materials of electric or electronic machines, casing materials of electronic elements, or of antistatic materials. In addition, said polypyrrole films and polypyrrole layers can preferably be used for carrier tapes in which electronic accessories such as ICs, condensers, transistors, LSIs are sealed and stored in containers and are transferred, TAB tapes, trays for carrying materials, containers, or soling materials for trays or containers. Further, said polypyrrole films and polypyrrole layers can preferably be used for housing materials, casing materials, and chassis for shielding electromagnetic wave for preventing electromagnetic wave, protecting electronic devices and elements from static electricity and electromagnetic wave. Moreover, said polypyrrole films and polypyrrole layers can preferably be used for electromagnetic wave shielding materials on floor surfaces, ceiling surfaces, wall surfaces of buildings for preventing leakage of electromagnetic wave and invasion of exotic electromagnetic wave emitted from electronic machines and communication devices such as OA equipment, information technology equipment, computer control equipment, computer control equipment, and the like and can preferably be used for conductive films for antistatic purposes for cards such as magnetic cards, IC cards, and the like. Moreover, other than above uses, said polypyrrole films and polypyrrole layers can preferably be used for electromagnetic interference restraining sheets or films for shielding electromagnetic wave and gasket materials of shielding electromagnetic wave, films for labeling on electronic machines or on glass windows with purposes of shielding electromagnetic wave. Said polypyrrole films and polypyrrole layers can preferably be used as energizing purposes, for conductive films used for the purpose of providing conductive layers such as conductive patterns and the like on surfaces of matrix as each kind of electric accessories or conductive layers of printing substrates. Said polypyrrole films and polypyrrole layers can preferably be used as several kinds of contact points adhering semiconductor elements such as IC, LSI, and the like to such substrates as lead frames, ceramic circuit boards, glass epoxy circuit boards, and the like, electric contact materials of electrics, or electronic accessories such as contact rubbers, and the like, bonding materials which bond and fix circuit boards and electrically bond electrodes thereof, circuits to electrical equipments, complex accessories provided with cable functions or connector functions, and prefabricated connection boxes for CV cables.

Said polypyrrole films and polypyrrole layers can preferably be used as explosion proof tapes, electrodes for primary and secondary batteries, electrodes for capacitors, diodes, field-effect transistors, electroluminescence elements, electrochromic (EC) elements, EC displays, each kind of sensors (moisture, temperature, light, ion, gas, taste, pressure, and the like), thermoelectric conversion elements, solar cells, heat generators, ceramic release films, films for magnetic recording materials, films for photographs, dry films for conductive materials, tracing films, films for photosensitive materials, switches for keyboards of electric calculators and the like, low resistance tapes used for stator coils for rotating electric machines. Said polypyrrole films and polypyrrole layers can preferably be used for bearings for motors, materials for sliding parts, reinforcing plates of flexible printing boards as well. Said polypyrrole films and polypyrrole layers can preferably be used for above mentioned purposes, however, they can more preferably be used for electrodes for capacitors, electrodes for secondary batteries, electroluminescence elements, EC displays, electromagnetic wave shielding materials, or antistatic materials required for high mechanical strength and flexibility and further, they can preferably be used for the above mentioned purposes required for high mechanical strength and flexibility.

### EXAMPLES

Hereinafter, Examples and Comparative Examples are shown, however, the present invention is not limited to these Examples and Comparative Examples.

### Example 1

Pyrrole and salt composed of dopant ion stated in Table 1 (supporting electrolytes) was dissolved into solvents stated in Table 1 by publicly known stirring methods, and concentration of pyrrole (monomer) was adjusted to 0.25 mol/l and the electrolytic solutions which contain 0.5 mol/l of supporting electrolytes was prepared. In said electrolytes, as plate type working electrodes, metal electrodes stated in Table 1 were used and Pt electrodes were used, as counter electrodes, and electrochemical polymerization was conducted by a constant current method with current density of 0.2 (mA/cm²), thereby forming polypyrrole layers on working electrodes. Said polypyrrole layers were immersed in acetone followed by stripping off from working electrodes with tweezers, thereby obtaining polypyrrole films with the film thickness stated in Table 1.

### Examples 2 to 11

Polypyrrole films in each of the Examples with a film thickness stated in Tables 1 to 3 were obtained by the same methods as in Example 1 except that electrolytic solutions were prepared using solvents and supporting electrolytes stated in Tables 1 to 3 and that metal electrodes of Tables 1 to 3 were used as working electrodes.

### Comparative Examples 1 to 3

Polypyrrole films in each of the Examples with a film thickness stated in Table 3 were obtained by the same methods as in Example 1 except that electrolytes were prepared using solvents and supporting electrolytes stated in Table 3 and that non-metal electrodes and metal electrodes of Table 3 were used as working electrodes.

In addition, supporting electrolytes in Tables 1 to 3 are as follows.

TBABF₄: tetrabutylammonium tetrafluoroborate

TBACF₃SO₃: tetrabutylammonium trifluoromethane sulfonate

DBSNa: sodium dodecylbenzensulfonate

TBAPF₆: tetrabutylammonium hexafluorophosphate

TABLE 1

| | | | Example | | | | | |
|---|---|---|---|---|---|---|---|---|
| | | | 1 | 2 | 3 | 4 | 5 | 6 |
| Condition of | solvent | | Methyl | Methyl | 1-octanol | 1,2-dimethoxy- | 2- | 2-phenoxy- |
| electrochemical | | | benzoate | benzoate | | ethane | phenoxy- | ethanol |
| polymerization | | | | | | | ethanol | |
| | Supporting electrolyte | | TBABF₄ | TBABF₄ | TBABF₄ | TBABF₄ | TBABF₄ | TBABF₄ |
| | working | metal | Ni | Ti | Ni | Ti | Ti | Pt |
| | electrode | electrode | | | | | | |
| | | Non-metal | | | | | | |
| | | electrode | | | | | | |
| Film | Film thickness (μm) | | 20 | 32 | 40 | 31 | 42 | 25 |
| | Tensile | value | 75.0 | 83.4 | 96.8 | 84.9 | 63.5 | 75.9 |
| | strength | (MPa) | | | | | | |
| | | evaluation | ⊚ | ⊚ | ⊚ | ⊚ | ◯ | ⊚ |

| | | | | | | |
|---|---|---|---|---|---|---|
| Tensile breaking | 8.9 | 16.7 | 9.4 | 18.4 | 14.6 | 35.4 |
| elongation(%) | | | | | | |

TABLE 2

| | | | Example | | | |
|---|---|---|---|---|---|---|
| | | | 7 | 8 | 9 | 10 |
| Condition of | solvent | | Methyl | Propylene | Methyl | Methyl |
| electrochemical | | | benzoate | carbonate | benzoate | benzoate |
| polymerization | Supporting electrolyte | | TBACF₃SO₃ | TBABF₄ | TBACF₃SO₃ | TBACF₃SO₃ |
| | working | metal | Ti | Ti | Ti | Ni |
| | electrode | electrode | | | | |
| | | Non-metal | | | | |
| | | electrode | | | | |
| Film | Film thickness (μm) | | 21 | 14 | 55 | 10 |
| | Tensile | Value | 63.5 | 92.3 | 68.0 | 89.3 |
| | strength | (MPa) | | | | |
| | | evaluation | ◯ | ⊚ | ⊚ | ⊚ |

| | | | | |
|---|---|---|---|---|
| Tensile breaking | 35.4 | 11.5 | 90.0 | 29.5 |
| elongation (%) | | | | |

TABLE 3

| | | | Example | Comparative Example | | |
|---|---|---|---|---|---|---|
| | | | 11 | 1 | 2 | 3 |
| Condition of | solvent | | Methyl benzoate | Methyl | 1,2-dimethoxy- | H₂O |
| electrochemical | | | | benzoate | ethane | |
| polymerization | Supporting electrolyte | | TBAPF₆ | TBABF₄ | TBABF₄ | DBSNa |
| | working | metal | Ti | | | Pt |
| | electrode | electrode | | | | |
| | | Non-metal | | ITO glass | ITO glass | |
| | | electrode | | | | |
| Film | Film thickness (μm) | | 12 | 24 | 34 | 35 |
| | Tensile | Value | 62.2 | 39.4 | 16.7 | 29.0 |
| | strength | (MPa) | | | | |
| | | evaluation | ◯ | X | X | X |

| | | | | |
|---|---|---|---|---|
| Tensile breaking | 7.3 | 8.2 | 8.8 | 4.0 |
| elongation (%) | | | | |

(Evaluation)

Regarding polypyrrole films obtained in Examples 1 to 11 and in Comparative Examples 1 to 3, tensile strength and tensile breaking elongation were measured by using measuring methods as below. Results are shown in Tables 1 to 3. In addition, tensile strength was evaluated by the following criteria.

(Measuring Method)

Rectangular test strips with a width of 5 mm were prepared respectively, by cutting polypyrrole films obtained in Examples 1 to 11 and in Comparative Examples 1 to 3 into rectangular strips with a length of 20 mm, followed by processing aluminum tab providing tab spaces of about 4 mm. Using each test strip, and depending on a film tensile test (strength) of JIS K7127, tensile strength and tensile breaking elongation was measured at a test speed of 0.5 mm/min by using publicly known devices. In addition, in measuring tensile strength and tensile breaking elongation, a test machine “INSTRON5582” was used for measurement.

(Evaluation Criteria)

⊚: Very good tensile strength showing higher tensile strength compared with conventional tensile strength of high performance plastics for general purposes.

◯: Good tensile strength showing the same tensile strength compared with conventional tensile strength of high performance plastics for general purposes and preferable for the use requiring high strength.

×: Same tensile strength compared with conventional polypyrrole films and not preferable for the use requiring high strength.

(Result)

In polypyrrole films in Example 1, methyl benzoate was used as solvents of electrolytes at the time of electrochemical polymerization, and in said electrolytes, BF₄⁻ was included as dopant anions in said electrolytes and Ni metal electrodes were used for electrochemical polymerization, and therefore, tensile strength of 75.0 MPa was obtained, which was substantially the same tensile strength as that of usual high performance plastics for general purposes. On the other hand, in polypyrrole in Comparative Example 1, methyl benzoate was used as solvents of electrolytes at the time of electrochemical polymerization, and in said electrolytes, BF₄⁻ was included as dopant anions but since ITO glasses which are non-metal electrodes were used, tensile strength of 39.4 MPa was obtained, which was lower than that of usual high performance plastics for general purposes. In Comparative Example 3, water was used as solvents of electrolytes at the time of electrochemical polymerization and in said electrolytes, as dopant anions, dodecylbenzenesulfonate ion was included and by using Pt metal electrodes, electrochemical polymerization was conducted and therefore, tensile strength of 29.0 MPa was obtained, which was further lower than that of usual high performance plastics for general purposes.

In polypyrrole films of Example 2, as solvents of electrolytes, methylbenzoate was used, and as dopant anions, BF₄⁻ was included in said electrolytes, but since Ti electrodes were used as metal electrodes unlike in Example 1, substantially the same tensile strength was obtained as that of usual high performance plastics for general purposes. In addition, polypyrrole films in Example 2 showed about the double tensile breaking elongation compared with that of Example 1, which showed that the films were hard to break against impact shock and excellent as protection films.

In polypyrrole films of Example 3, as solvents of electrolytes, 1-octanol was used as solvents of electrolytes at the time of electrochemical polymerization, and as dopant anions, BF₄⁻ was included in said electrolytes, and since Ni metal electrodes were used for electrochemical polymerization, tensile strength of 96.8 MPa was obtained. Polypyrrole films of Example 3 showed excellent tensile strength particularly superior to that of usual high performance plastics for general purposes. In polypyrrole films of Example 4, 1,2-dimethoxyethane was used as solvents of electrolytes at the time of electrochemical polymerization, and as dopant anions, BF₄⁻ was included in said electrolytes, and since Ni metal electrodes were used for electrochemical polymerization, tensile strength of 84.9 MPa was obtained, which was the same as or greater than that of usual high performance plastics for general purposes. On the other hand, since polypyrrole films of Example 2 used ITO glasses which are non-metal electrodes for electrochemical polymerization unlike polypyrrole films of Example 4, tensile strength of 16.7 MPa was obtained, which was lower than that of usual high performance plastics for general purposes.

Polypyrrole films of Example 4 had higher tensile strength than that of Comparative Example 2 and tensile breaking elongation was almost the double. In polypyrrole films in Examples 5 and 6, 1,2-dimethoxyethane was used as solvents of electrolytes at the time of electrochemical polymerization, and as dopant anions, BF₄⁻ was included in said electrolytes, and metal electrodes were used for electrochemical polymerization. Although tensile strength of polypyrrole films in both Examples 5 and 6 were high, polypyrrole films in Example 6 which used Pt metal electrodes as working electrodes obtained more than double the tensile breaking elongation as high as that of polypyrrole films in Example 5 which used Ti metal electrodes as working electrodes.

In Example 7, as in Example 2, methyl benzoate was used as solvents of electrolytes at the time of electrochemical polymerization and polypyrrole films were obtained by using Ti metal electrodes as working electrodes. However, in Example 7, unlike in Example 2, as dopant anions, since CF₃SO₃⁻ was used, films with large tensile breaking elongation, with flexibility, and with property of being hard to break against impact shock were obtained.

In polypyrrole films of Examples 8 to 10, methyl benzoate was used as solvents of electrolytes at the time of electrochemical polymerization, and metal electrodes made of titanium or nickel were used as working electrodes, and polypyrrole films were obtained by electrochemical polymerization. Polypyrrole films of Examples 8 to 10 showed excellent tensile strength of not less than 87 MPa and compared with that of usual engineering plastics for general purposes, superior tensile breaking elongation was shown. In particular, polypyrrole films in Example 9 showed very excellent tensile breaking elongation.

Polypyrrole films of Example 11 used methyl benzoate as solvents of electrolytes at the time of electrochemical polymerization metal electrodes made of titanium or nickel were used as working electrodes, and polypyrrole films were obtained by electrochemical polymerization.

Polypyrrole films of Example 11 had the same tensile strength as that of conventional usual high performance plastics for general purposes and were provided with conductivity and high mechanical strength.

Polypyrrole films of Examples 1 to 11 were obtained as single films by stripping off polypyrrole layers from working electrodes. However, when substrates provided with metal surfaces subject to coating of polypyrrole layers were used for working electrodes, polypyrrole layers are used as they are as protection layers without stripping off polypyrrole layers from substrates. Since said polypyrrole layers are excellent in mechanical strength, protection not only against physical force but also against static electricity and the like is available. Further, when metals forming metal surfaces are Ti metal electrodes or Pt metal electrodes, as in polypyrrole films, compared with when Ni metal electrodes are used, protection layers with larger tensile breaking elongation and with better flexibility and with difficulty in breaking against impact shock can be obtained.

### INDUSTRIAL APPLICABILITY

By using the production methods of the present invention, polypyrrole films' with high tensile strength can be obtained. In addition, by using the forming methods of coating layers of the present invention, polypyrrole layers with high tensile strength can be obtained on metal surfaces of metal substrates. Since said polypyrrole films and said polypyrrole layers have conductivity and good mechanical strength, they can preferably be used as electrode layers, induction layers, conductive layers, coating layers, or protection layers requiring conductivity and good mechanical strength in the elements, materials, accessories, or devices exemplified as follows; electrodes for primary batteries, electrodes for secondary batteries, electrodes for capacitors, diodes, field-effect transistors, electroluminescence elements, electrochromic elements, each kind of sensors (moisture, temperature, light, ion, gas, taste, pressure, and the like), thermoelectric conversion elements, shielding materials for electromagnetic wave, antistatic materials, solar cells, exterior accessories for automobiles, functional parts for interiors of automobiles, fuel related accessories, and accessories for air crafts, and the like.

In addition, said polypyrrole films and said substrates can preferably be used for conductive layers or films formed into office automations, homes, office management, or machines and tools for automobiles and for aircrafts or accessories thereof, construction materials, medical equipments, and the like.

Polypyrrole films of the present invention and metal materials in which polypyrrole layers are formed on a metal surface of the present invention can further preferably be used for accessories, elements, devices, and materials; electrodes for capacitors using said polypyrrole films or said polypyrrole layers, electrodes for secondary batteries, electroluminescence elements, EC displays, shielding materials for electromagnetic wave, antistatic materials, electrodes for capacitors with flexibility, electrodes for secondary batteries with flexibility, electroluminescence elements with flexibility, EC displays with flexibility, shielding materials for electromagnetic wave with flexibility, and antistatic materials with flexibility.

What is claimed:

1. Process for producing polypyrrole films obtained by forming polypyrrole layers on working electrodes by electrochemical polymerization methods which use pyrrole and/or pyrrole derivatives as monomers, followed by stripping off said polypyrrole layers, wherein said electrochemical polymerization methods use electrolytes which include organic compounds comprising at least one bond or one functional group of ether bond, ester bond, carbonate bond, hydroxyl group, nitro group, sulfone group, and nitryl group and/or halogenated hydrocarbon as solvents, said electrolytes include anions including trifluoromethanesulfonate ion and/or plural of fluorine atoms which bond to central atom and said working electrodes are metal electrodes.

2. Process for producing polypyrrole films as set forth in claim 1, wherein a bond or a functional group which said organic compounds have are ester bond and/or hydroxyl group functional group.

3. Polypyrrole films comprising conductive polymers produced by a production method set forth in claim 1 as resin components.

4. Polypyrrole films as set forth in claim 3, wherein tensile strength is not less than 60 MPa.

5. Processes for forming coating layers forming polypyrrole layers on metal surfaces of substrates by electrochemical polymerization methods which use pyrrole and/or pyrrole derivatives as monomers, said substrates are used as working electrodes in said electrochemical polymerization methods, said electrochemical polymerization methods use electrolytes which include organic compounds comprising at least one bond or one functional group of ether bond, ester bond, carbonate bond, hydroxyl group, nitro group, sulfone group, and nitryl group and/or halogenated hydrocarbon as solvents, and said electrolytes include anions which include trifluoromethanesulfonate ion and/or plural of fluorine atoms which bond to central atom.

6. Substrates with polypyrrole layers formed on metal surfaces of substrates by processes for forming coating layers set forth in claim 5.

7. Electrodes for capacitors, electrodes for secondary batteries, electroluminescence elements, EC displays, magnetic wave shielding materials, and antistatic materials using polypyrrole films set forth in claim 3.

8. Electrodes for capacitors with flexibility, electrodes for secondary batteries with flexibility, electroluminescence elements with flexibility, EC displays with flexibility, magnetic wave shielding materials with flexibility, and antistatic materials with flexibility using polypyrrole films set forth in claim 3.

9. Electrodes for capacitors, electrodes for secondary batteries, electroluminescence elements, EC displays, magnetic wave shielding materials, and antistatic materials using substrates with polypyrrole films formed set forth in claim 6.

10. Electrodes for capacitors with flexibility, electrodes for secondary batteries with flexibility, electroluminescence elements with flexibility, EC displays with flexibility, magnetic wave shielding materials with flexibility, and antistatic materials with flexibility using substrates with polypyrrole films formed set forth in claim 6.
